(19) United States
(12) Patent Application Publication
(10) Pub. No.: US 2014/0337584 A1
(43) Pub. Date: Nov. 13, 2014

(54) CONTROL APPARATUS, ANALYSIS APPARATUS, ANALYSIS METHOD, AND COMPUTER PRODUCT

(71) Applicant: FUJITSU LIMITED, Kawasaki-shi (JP)

(72) Inventors: Shuji TAKADA, Kawasaki (JP); Takatoshi FUKUDA, Sagamihara (JP)

(73) Assignee: Fujitsu Limited, Kawasaki (JP)

(21) Appl. No.: 14/341,186

(22) Filed: Jul. 25, 2014

Related U.S. Application Data
(63) Continuation of application No. PCT/JP2012/052022, filed on Jan. 30, 2012.

(51) Int. Cl. G06F 12/08

(52) U.S. Cl. CPC G06F 12/0835; G06F 12/0806; G06F 2212/621
USPC 711/143; 711/146

(57) ABSTRACT

A cache controller receives a reference request from a CPU executing a program in which information indicative of a reference request specifying in shared memory, an area not having an update request and information indicative of a snoop reference request are distinguished from one another. When the reference request specifying an area not having the update request is received, the cache controller acquires from the shared memory and without performing a snoop process, information stored in the specified area. The cache controller stores the information acquired from the shared memory to the cache memory of the CPU executing the program.

### CROSS REFERENCE TO RELATED APPLICATIONS

This application is a continuation application of International Application PCT/JP2012/052022, filed on Jan. 30, 2012 and designating the U.S., the entire contents of which are incorporated herein by reference.

### FIELD

The embodiments discussed herein are related to a control apparatus, an analysis apparatus, an analysis method, and a computer product.

### BACKGROUND

In recent years, to enhance throughput, a multi-core processor system is known that has plural cores mounted on a single chip. To improve throughput, each of the cores has cache memory. To enable the plural cores to execute a job concurrently, each cache memory has to have coherence of the stored contents concerning the job. Imparting coherence to the stored contents is called cache coherence. To perform the cache coherence, a cache controller controlling the cache memory executes a snoop process.

According to a related technique, for example, a dummy variable is inserted into program code so that a different variable is not assigned to the same cache line (see, e.g., Japanese Laid-Open Patent Publication No. 2001-160035).

For example, the cache controller controlling the cache memory switches the coherence control for each cache line between an invalidation mode and an update mode (see, e.g., Japanese Laid-Open Patent Publication No. 2001-34597).

For example, a technique is known in which the cache controller controlling the cache memory buffers invalidation requests and executes the invalidation when receiving a certain number or more requests (see, e.g., Japanese Laid-Open Patent Publication No. 2002-7371).

For example, a technique is known in which the cache line is subdivided so that, when another core performs an update, the cache controller invalidates only the updated block and validates the other blocks to be saved to the cache memory (see, e.g., Japanese Laid-Open Patent Publication Nos. 2000-267935 and 2009-151457).

For example, a technique is known in which the cache line is subdivided so that the cache controller imparts an exclusive access right bit to each of blocks in the subdivided cache line (see, e.g., Published Japanese-Translation of PCT Application, Publication No. 2008/155844).

For example, a technique is known in which a CPU has two caches so that code is generated such that two data concurrently referred to by the CPU are stored in different caches, thereby preventing references to the two data from contending with each other (see, e.g., Japanese Laid-Open Patent Publication No. 2002-7213).

For example, a technique is known in which cache memory is not accessed when an address specified by an access request is a first address whereas the cache memory is accessed when the address specified by the access request is a second address (see, e.g., Japanese Laid-Open Patent Publication No. 2009-271606).

A technique is also known in which code is generated such that data concerning variables included in one instruction are stored in the same cache line (see, e.g., Japanese Patent No. 3758984).

Nonetheless, since each core has cache memory, an increase in the number of cores leads to an increase in the time consumed for one snoop process, resulting in a lower throughput.

### SUMMARY

According to an aspect of an embodiment, a control apparatus, for each memory configured to temporarily store first information that is stored in a shared memory shared by plural CPUs respectively having the memories or second information that is to be stored in the shared memory, controls access from each of the CPUs to the memories. The control apparatus includes a receiving unit configured to receive any one among a first and a second reference request from a CPU executing a program in which information indicative of the first reference request specifying in the shared memory, an area not having an update request is distinguished from information indicative of the second reference request specifying in the shared memory, an area having an update request; an acquiring unit configured to acquire from the shared memory and when the receiving unit receives the first reference request, the first information stored in the specified area, the acquiring unit acquiring the first information without performing for the first information stored in the specified area or the second information, a snoop process that is based on a storage state of the memory of the CPU executing the program; and a storing unit that stores into the memory of the CPU executing the program, the information acquired by the acquiring unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are explanatory views of operation example 1 of a cache controller;

FIG. 2 is an explanatory view of operation example 2 of a cache controller 121;

FIGS. 3A and 3B are explanatory views of operation example 3 of the cache controller 121;

FIG. 4 is an explanatory view of operation example 4 of the cache controller 121;

FIG. 5 is an explanatory view of a hardware configuration example of a multi-core processor system 100;

FIG. 6 is a block diagram of an example of functions of the cache controller 121;

FIG. 7 is an explanatory view of an example of state transition in a case of a snoop reference request or a snoop update request;

FIG. 8 is an explanatory view of an example of state transition in a case of a non-snoop reference request or a non-snoop update request;

FIG. 9 is an explanatory view of an operation example of an analysis apparatus;

FIG. 10 is a block diagram of an example of functions of an analysis apparatus 900;

FIG. 11 is a flowchart of an example of an analysis procedure by the analysis apparatus 900;

FIG. 12 is a flowchart of an analysis process example depicted in FIG. 11 (step S1102);

FIG. 13 is a flowchart of a first example of a rebuilding process (step S1103) depicted in FIG. 11; and

FIG. 14 is a flowchart of a second example of the rebuilding process (step S1103) depicted in FIG. 11.

### DESCRIPTION OF EMBODIMENTS

Embodiments of a control apparatus will be described in detail with reference to the accompanying drawings. Herein, the control apparatus is a memory controller that controls cache memory included in each CPU of a multi-core processor system. In a first embodiment, operations will be described of the control apparatus receiving a reference request and an update request from the CPUs in the multi-core processor system. In a second embodiment, during the execution of a program by a simulator, an analysis apparatus analyzes whether a reference request and an update request are present for each area in shared memory specified by the reference request or the update request.

The first embodiment will be described. If during the execution of a program there occurs a condition determination such as “If(i_packet[32]==1)” and a cache miss, a snoop process takes place to see whether data of i_packet[32] is the most recent and whether a CPU is present that does not rewrite data. The value of i_packet[32] is a fixed value in a program and if the value is only referred to, the snoop process is unnecessary. Thus, in the first embodiment, when a request is made for referring to an area in the shared memory not specified by an update request, data of the area does not change as a result of the snoop process, the control apparatus acquires data of the area from the shared memory without performing the snoop process. This enables the control apparatus to reduce the number of unnecessary snoop processes to achieve improvement of the throughput.

If during the execution of a program, a substitution process such as “packet=4” occurs, a snoop process takes place to see whether a CPU is present that does not retain the same cache line. If no CPUs refer to the value of the packet, the snoop process is unnecessary. Thus, in the first embodiment, when a request is made for referring to an area in the shared memory not specified by an update request, the control apparatus acquires data of the area from the shared memory without performing the snoop process and overwrites update data included in the update request concerning the acquired data. This enables the control apparatus to reduce the number of unnecessary snoop processes, thereby achieving improved throughput.

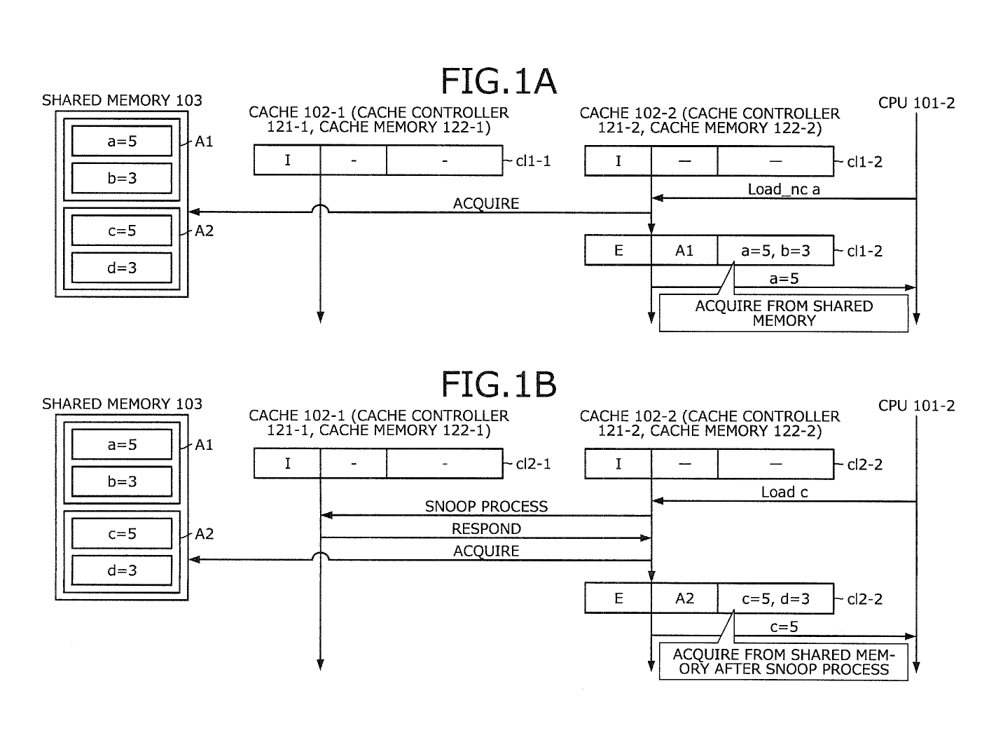

FIGS. 1A and 1B are explanatory views of operation example 1 of a cache controller. FIG. 1A depicts an operation example when a cache controller 121 receives a reference request specifying an area of shared memory 103 not having an update request. FIG. 1B depicts an operation example when the cache controller 121 receives a reference request specifying an area of the shared memory 103 having an update request. A reference request specifying an area of the shared memory 103 not having an update request is hereinafter referred to as “non-snoop reference request”. A reference request specifying an area of the shared memory 103 having an update request is hereinafter referred to as “snoop reference request”.

For example, in execution code, information indicative of the non-snoop reference request is described as “Load_nc”. For example, in the execution code, information indicative of the snoop reference request is described as “Load”. The execution code is information identifiable by a CPU 101 such as assembly language and includes instruction information. The instruction information can be, for example, information indicative of an update request, information indicative of a reference request, and information indicative of operation instruction. The execution code is information obtained by building source code described with a computer processing language such as C language by the designer. “Building” refers to work for generating execution code by source code that performs compiling and library linking.

A multi-core processor system 100 includes plural CPUs 101, the shared memory 103, and a cache 102 disposed for each of the CPUs 101. The cache 102 includes cache memory 122 and a cache controller 121 that controls access to the cache memory 122. A detailed hardware configuration of the multi-core processor system 100 will be described later with reference to the drawings.

The cache memory 122 temporarily stores data stored in the shared memory 103 and data to be stored into the shared memory 103. The cache memory 122 has “Tag part” and “Data part” for each cache line cl and the “Tag part” has “State” and “Address”.

For example, a first address of an area in the shared memory 103 to be a storage destination is entered into “Address”. Data of an area in the shared memory 103 corresponding to the size of one cache line cl from the area in the shared memory 103 indicated by the first address stored in “Address” is entered into “Data part”.

The state of the cache line cl is entered into “State”. The state of the cache line cl includes four states, “M”, “E”, “S”, and “I”. “Modified” will hereinafter be described simply as “M”, “Exclusive” will hereinafter be described simply as “E”, “Shared” will hereinafter be described simply as “S”, and “Invalid” will hereinafter be described simply as “I”.

Storage of “M” in “State” of a cache line cl indicates presence in only the cache memory 122 having the cache line cl and a modification from the value on the shared memory 103. Storage of “E” in “State” of a cache line cl indicates presence in only the cache memory 122 having the cache line cl but the coincidence with the value on the shared memory 103. Storage of “E” in “State” of a cache line cl indicates presence in only the cache memory 122 having the cache line cl and coincidence with the value on the shared memory 103.

Storage of “S” in “State” of a cache line cl indicates presence in not only the cache memory 122 having the cache line cl but also in other cache memory 122 and coincidence with the value on the shared memory 103. Storage of “I” in “State” of a cache line cl indicates that the cache line cl is invalid.

In the example depicted in FIGS. 1A and 1B, to facilitate understanding, each cache line cl stores “area information” and “Data” in the mentioned order in place of “State” and “Address”.

Referring to FIG. 1A, an operation example will be described when a cache controller 121-2 receives a non-snoop reference request. Entry of “I” in cache lines cl1-1 and cl1-2 indicates that the value of a constant a is not entered in the cache memory 122.

The cache controller 121-2 receives a reference request from a CPU 101-2. For example, a signal line connecting the CPU 101-2 and the cache controller 121-2 is separated corresponding to the non-snoop reference request and the snoop reference request. For example, if the reference request is “Load_nc”, the CPU 101-2 outputs an enable signal to a signal line corresponding to “Load_nc”, whereas if the reference request is “Load”, the CPU 101-2 outputs an enable signal to a signal line corresponding to “Load”. Accordingly, the cache controller 121-2 can determine which reference request has been received based on to which signal line the enable signal is input.

Upon receiving a non-snoop reference request, the cache controller 121-2 without executing the snoop process, acquires from the shared memory 103, data stored in an area specified by the reference request. One cache line of the cache may be managed by a data size larger than the data size processed by the CPU 101. In this embodiment, an area A1 is an area in the shared memory 103 corresponding to one cache line cl including the specified area. Thus, values of variables a and b stored in the area A1 are acquired. Even though a reference request occurs to refer to either the variable a or b stored in the area A1, values of both the variables a and b are acquired as the one cache line cl data.

The cache controller 121-2 then stores data acquired from the shared memory 103 into the cache memory 122-2. The snoop process is a process performed to cause the stored contents of the cache memory 122-2 to coincide with the stored contents of the other cache memories 122 according to the state of storage in the cache memory 122.

For example, if the cache controller 121-2 receives “Load_nc”, the cache controller 121-2 sends a reference request to a memory controller controlling the shared memory 103, to acquire data stored in the area A1. For example, the reference request specifies a first address of an area where data to be referred to is stored.

The memory controller controlling the shared memory 103 then accesses the area A1 to read data stored therein. The memory controller controlling the shared memory 103 sends the read data to the request source cache controller 121-2. In this case, the cache controller 121-2 acquires values of the variables a and b. Even though a reference request for either the variable a or b occurs, values of both the variables a and b are acquired as data corresponding to one cache line cl.

For example, the cache controller 121-2 then correlates and stores into the cache memory 122-2, the acquired values of the variables a and b with the first address of the area A1. In FIG. 1A, as the area information, “A1” replaces the first address of the area A1 and is entered in the cache line cl1-2. The cache controller 121-2 then sets “State” of the cache line cl1-2 storing the acquired data to “E”. The cache controller 121-2 then responds to the CPU 101-2. In the case of a reference request, the cache controller 121-2 issues data corresponding to the reference request.

Referring next to FIG. 1B, an operation example will be described when the cache controller 121-2 receives a snoop reference request. Entry of “I” in the cache lines cl2-1 and cl2-2 indicates that the value of a variable c is not entered in the cache memory 122.

As described above, the cache controller 121-2 receives a reference request. If the cache controller 121-2 receives a snoop reference request, the cache controller 121-2 executes a snoop process according to the contents stored in the cache memory 122.

For example, the cache controller 121-2 determines whether the variable c is stored in the cache memory 122. If it is determined that the variable c is not stored in the cache memory 122-2, the cache controller 121-2 subjects the other cache 102-1 to a snoop process for the variable c.

For example, if the variable c is not stored in the cache memory 122-1, in this case, since the value of the variable c is not obtained through the snoop process, the cache controller 121-2 acquires from the shared memory 103, data stored in a specified area. An area A2 is an area in the shared memory corresponding to one cache line cl including the specified area. Thus, the value of the variable c and the value of a variable d that are stored in the area A2 are acquired. Even though a reference request to refer to either the variable c or d stored in the area A2 occurs, the values of both the variables c and d are acquired as data corresponding to one cache line cl.

The cache controller 121-2 then stores the acquired data and the first address of the area A2 into the cache memory 122. In FIG. 1B, in place of the first address of the area A2, “A2” is entered as the area information into the cache line cl2-2. The cache controller 121-2 then sets “E” as “State” of the cache line cl2-2 storing the acquired data. The cache controller 121-2 then responds to the CPU 101-2. In the case of a reference request, the cache controller 121-2 issues reference data corresponding to the reference request.

According to a comparison of FIGS. 1A and 1B, the cache controller 121 does not execute the snoop process in the case of a reference request specifying an area in the shared memory 103 not having an update request, thereby reducing the processing time consumed for the snoop process. As a result, the throughput can be enhanced.

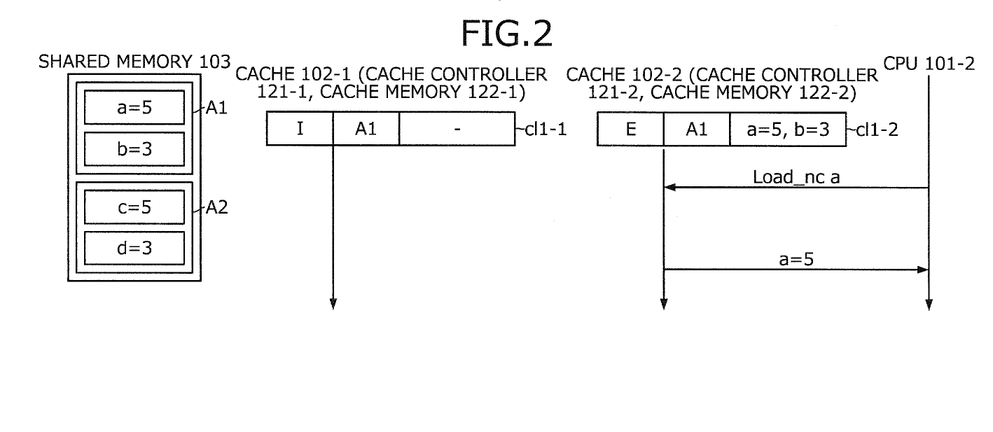

FIG. 2 is an explanatory view of operation example 2 of the cache controller 121. FIG. 2 depicts an operation example in a case where, when the cache controller 121-2 receives a non-snoop reference request, the cache memory 122 already has data stored in the shared memory 103 in an area specified by the reference request.

Upon receiving a non-snoop reference request, the cache controller 121-2 determines whether the cache memory 122 has data stored in a specified area in the shared memory 103 specified by the reference request. As described above, in the case of receiving a non-snoop reference request, the cache controller 121-2 does not perform the snoop process.

For example, the cache controller 121-2 searches the cache memory 122 for a cache line cl where any one of “M”, “E”, and “S” is set in “State”. For example, the cache controller 121-2 determines whether an address specified by the reference request is included between an address stored in the searched cache line cl and an address obtained by adding the data size of one cache line cl to the address stored in the searched cache line cl. If so, the cache controller 121-2 determines that the cache memory 122-2 holds data stored in the specified area of the shared memory 103 specified by the reference request. If not, the cache controller 121-2 determines that the cache memory 122 does not hold data stored in the specified area of the shared memory 103 specified by the reference request.

If the cache memory 122-2 holds data stored in the specified area of the shared memory 103 specified by the reference request, the cache controller 121-2 reads out the data from the cache memory 122-2. The cache controller 121-2 then responds to the CPU 101-2.

If the cache memory 122 does not hold data stored in the specified area specified by the reference request, the cache controller 121-2 reads out data of the specified area from the shared memory 103 as depicted in FIGS. 1A and 1B.

This enables the cache controller 121-2 to immediately respond to the CPU 101-2 as long as the cache memory 122 holds data to be referred to for the reference request of the area in the shared memory 103 not having an update request. Therefore, the cache controller 121-2 does not execute the snoop process, thereby enabling reductions in the processing time consumed for the snoop process and improved throughput.

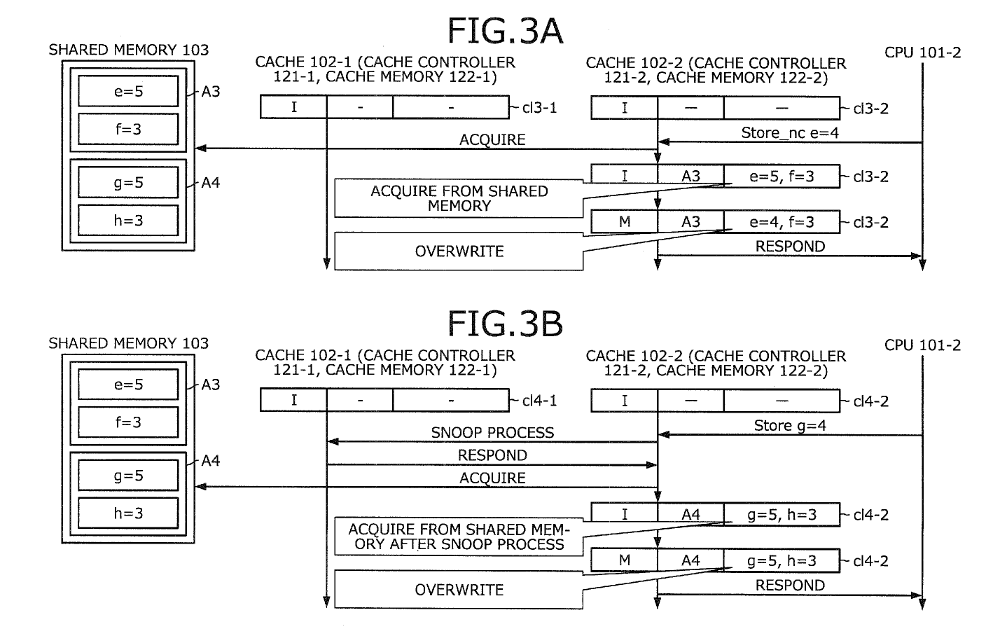

FIGS. 3A and 3B are explanatory views of operation example 3 of the cache controller 121. FIG. 3A depicts an operation example when the cache controller 121-2 receives a non-snoop update request. FIG. 3B depicts an operation example when the cache controller 121-2 receives an update request specifying an area of the shared memory 103 having a reference request. An update request specifying an area of the shared memory 103 not having a reference request will hereinafter be referred to as a “non-snoop update request”. An update request specifying an area of the shared memory 103 having a reference request will hereinafter be referred to as a “snoop update request”.

For example, in a program, code representative of a non-snoop update request is described as “Store_nc” while code representative of a snoop update request is described as “Store”.

With reference to FIG. 3A, an operation example will be described when the cache controller 121-2 receives the non-snoop update request. Entry of “I” in cache lines cl3-1 and cl3-2 indicates that the value of a variable e is not entered in the cache memory 122.

The cache controller 121-2 receives an update request from the CPU 101-2. For example, a signal line connecting the CPU 101-2 and the cache controller 121-2 is separated corresponding to the non-snoop update request and the snoop update request. For example, if the update request is “Store_nc”, the CPU 101-2 outputs an enable signal to a signal line corresponding to “Store_nc”, whereas if the update request is “Store”, it outputs an enable signal to a signal line corresponding to “Store”. Accordingly, the cache controller 121-2 can determine which update request has been received based on to which signal line the enable signal is input.

Upon receiving a non-snoop update request, the cache controller 121-2 without executing the snoop process, acquires from the shared memory 103, data stored in an area specified by the update request. The cache controller 121-2 then stores data acquired from the shared memory 103 into the cache memory 122-2.

For example, if the received update request is “Store_nc”, the cache controller 121-2 sends to a memory controller controlling the shared memory 103, an update request to acquire data stored in a specified area in the shared memory 103 specified by the update request. For example, the update request specifies a first address of an area where data to be updated is stored.

The memory controller controlling the shared memory 103 then accesses the specified area and reads data stored therein. The memory controller controlling the shared memory 103 sends the read data to the request source cache controller 121-2. In this case, the cache controller 121-2 acquires values of the variable e and a variable f. Even though an update request occurs for either the variable e or f, values of both the variables e and f are acquired as data corresponding to one cache line cl.

For example, the cache controller 121-2 then correlates and stores into the cache memory 122, the acquired values of the variables e and f with the first address of the specified area specified by the received update request. For example, the cache controller 121-2 then overwrites update data included in the update request concerning the cache line cl3-2 storing the acquired data. The cache controller 121-2 sets “State” of the overwritten cache line cl3-2 to “M” and responds to the CPU 101-2. For example, in the case of an update request, the cache controller 121-2 notifies the CPU 101-2 of the completion of the update request.

With reference to FIG. 3B, an operation example will be described when the cache controller 121-2 receives a snoop update request. Entry of “I” in cache lines cl4-1 and cl4-2 indicates that the value of a variable g is not entered in the cache memory 122.

As described above, the cache controller 121-2 receives an update request from the CPU 101-2. If the cache controller 121-2 receives a snoop update request, the cache controller 121-2 executes a snoop process depending on the contents stored in the cache memory 122.

For example, the cache controller 121-2 determines whether the variable g is stored in the cache memory 122. If it is determined that the variable g is not stored in the cache memory 122-2, the cache controller 121-2 subjects the other cache 102-1 to a snoop process for the variable g. In this case, since the value of the variable g is not obtained through the snoop process, the cache controller 121-2 acquires data stored in a specified area from the shared memory 103. In this case, the values of the variable g and a variable h are acquired. Even though an update request occurs for either the variable g or h, the values of both the variables g and h are acquired as data corresponding to one cache line cl.

The cache controller 121-2 stores the acquired data into the cache memory 122-2. For example, the cache controller 121-2 overwrites the cache line cl4-2 storing the acquired data with update data included in the update request. The cache controller 121-2 sets “State” of the overwritten cache line cl4-2 to “M” and responds to the CPU 101-2. For example, in the case of an update request, the cache controller 121-2 notifies the CPU 101-2 of the completion of the update request.

According to a comparison of FIGS. 3A and 3B, the cache controller 121 does not execute the snoop process in the case of an update request specifying an area in the shared memory 103 not having a reference request, thereby reducing the processing time consumed for the snoop process. Thus, the throughput can be enhanced.

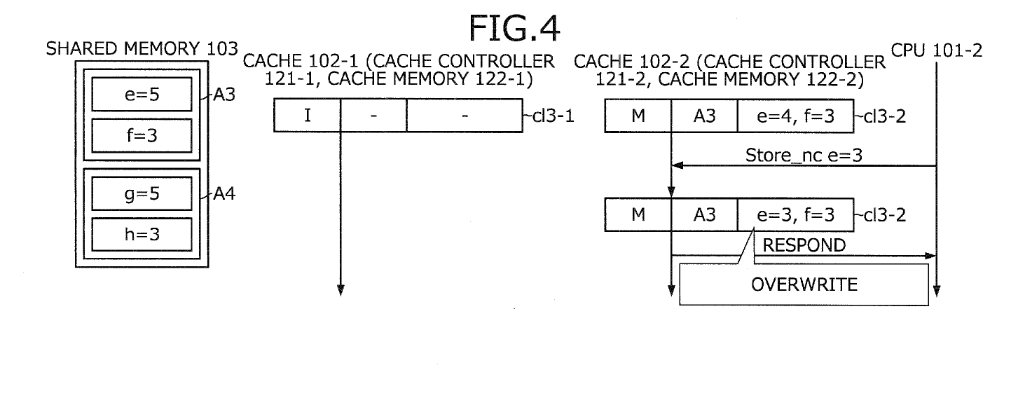

FIG. 4 is an explanatory view of operation example 4 of the cache controller 121. FIG. 4 depicts an operation example in a case where, when the cache controller 121 receives a non-snoop update request, the cache memory 122 already has data stored in a specified area in the shared memory 103 specified by the update request.

Upon receiving a non-snoop update request, the cache controller 121-2 determines whether the cache memory 122 has data stored in a specified area in the shared memory 103 specified by the update request. As described above, in the case of receiving a non-snoop update request, the cache controller 121-2 does not perform the snoop process.

For example, the cache controller 121-2 searches the cache memory 122 for a cache line cl where any one of “M”, “E”, and “S” is set in “State”. For example, the cache controller 121-2 determines whether an address specified by the update request is included between an address stored in the searched cache line cl and an address obtained by adding the data size of one cache line cl to the address stored in the searched cache line cl. If so, the cache controller 121-2 determines that the cache memory 122-2 holds data stored in the specified area of the shared memory 103 specified by the update request. If not, the cache controller 121-2 determines that the cache memory 122 does not hold data stored in the specified area of the shared memory 103 specified by the update request.

If the cache memory 122-2 holds data stored in the specified area of the shared memory 103 specified by the update request, the cache controller 121-2 overwrites update data of the update request concerning the cache line cl3-2 having the data stored in the specified area. In the example depicted in FIG. 4, 4 is overwritten by 3 as the value of the variable e. The cache controller 121-2 then responds to the CPU 101-2.

If the cache memory 122 does not hold data stored in the specified area specified by the update request, the cache controller 121-2 performs operations as depicted in FIGS. 3A and 3B.

Thus, the cache controller 121-2 is able to immediately respond to the CPU 101-2 as long as the cache memory 122 holds data to be updated for the update request of the area in the shared memory 103 not having the reference request. Therefore, the cache controller 121-2 does not execute the snoop process, whereby the cache controller 121-2 can reduce the processing time consumed for the snoop process and improve throughput.

Thus, if the cache memory 122-2 holds data of an area specified by the non-snoop update request, the cache controller 121-2 immediately overwrites the cache memory 122-2 with update data of the update request. Therefore, since the snoop process is not executed, the cache controller 121-2 can reduce the processing time consumed for the snoop process and thereby, improve throughput.

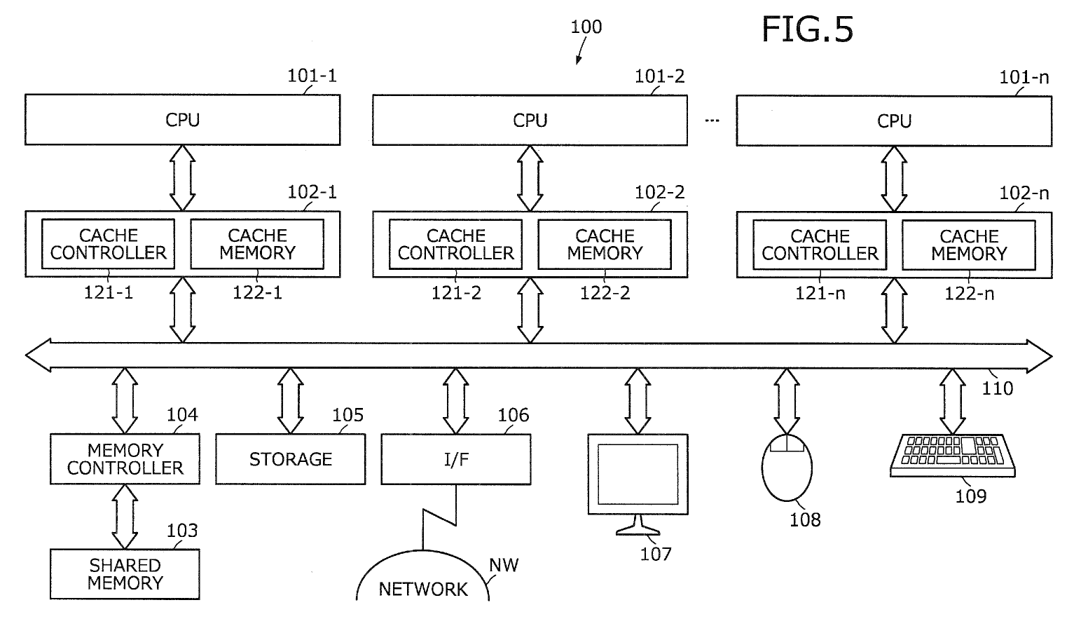

FIG. 5 is an explanatory view of a hardware configuration example of the multi-core processor system 100. In the multi-core processor system 100 of the present embodiment, the multi-core processor is a processor mounted with plural cores. As long as plural cores are provided, configuration may be implemented by a single processor mounted with plural cores or a processor group of single-core processors arranged in parallel. In the present embodiment, for simplification of description, a processor group of single-core processors arranged in parallel will be described by way of example.

The multi-core processor system 100 includes the CPUs 101, the cache 102 corresponding to each of the CPUs 101, the shared memory 103, a memory controller 104, and storage 105. The multi-core processor system 100 further includes an interface (I/F) 106, a display 107, a mouse 108, and a keyboard 109. A bus 110 is disposed to connect together the cache 102, the shared memory 103, the memory controller 104, the storage 105, the I/F 106, the display 107, the mouse 108, and the keyboard 109. The CPUs 101 are connected via the cache 102 to the bus 110.

For example, a CPU 101-1 provides overall control of the multi-core processor system 100. For example, the CPU 101-1 schedules to which CPUs 101 threads of an application activated by the user are assigned. The application is a job and the thread is a unit of processing by the CPU 101. For example, the CPUs 101-1 to 101-n execute the assigned threads. The cache 102 includes the cache controller 121 and the cache memory 122.

The shared memory 103 is shared by the CPUs 101 and used as a work area for the CPUs 101. The shared memory 103 can be for example RAM. The memory controller 104 controls access to the shared memory 103 from the CPUs 101. The storage 105 stores a boot program or an application program. The storage 105 can be for example a magnetic disk.

The I/F 106 is connected to a network NW such as a local area network (LAN), a wide area network (WAN), and the Internet through a communication line and is connected to other apparatuses through the network NW. The I/F 106 administers an internal interface with the network NW and controls the input and output of data with respect to external apparatuses. For example, a modem or a LAN adaptor may be employed as the I/F 106.

The display 107 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 107.

The keyboard 109 includes, for example, keys for inputting letters, numerals, and various instructions and performs the input of data. Alternatively, a touch-panel-type input pad or numeric keypad, etc. may be adopted. The mouse 108 is used to move the cursor, select a region, or move and change the size of windows. A track ball or a joy stick may be adopted provided each respectively has a function similar to a pointing device.

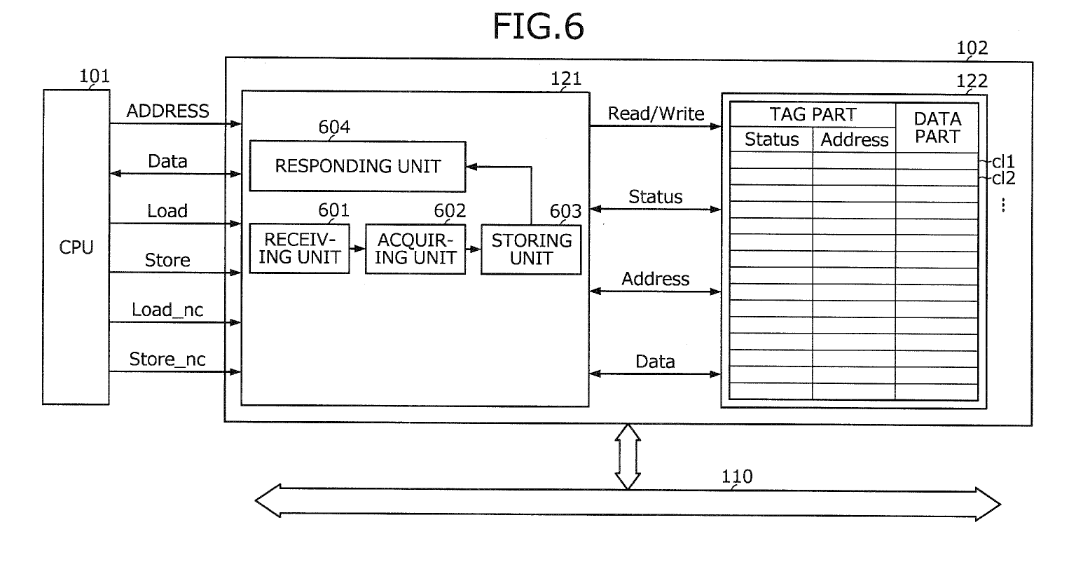

FIG. 6 is a block diagram of an example of functions of the cache controller 121. FIG. 6 depicts a connection relationship between the CPU 101 and the cache 102 and examples of functions of the cache controller 121. As described above, the cache memory 122 is a set of cache lines cl. Each cache line cl has “Tag part” and “Data part” fields. The “Tag part” has “State” and “Address” fields.

The CPU 101 and the cache controller 121 are connected to each other via signal lines through which “Address” and various requests are input from the CPU 101 to the cache controller 121 and via a signal line through which Data is mutually input or output. In this case, the various requests include “Load”, “Load_nc”, “Store”, and “Store_nc”. The cache controller 121 and the cache memory 122 are connected to each other via signal lines through which “State”, “Address”, and “Data” are mutually input and output. The cache controller 121 and the cache memory 122 are further connected to each other via a “Read/Write” signal line indicating whether a signal is a read signal or a write signal.

The cache controller 121 includes a receiving unit 601, an acquiring unit 602, a storing unit 603, and a responding unit 604. The units of the cache controller 121 are implemented by circuits such as a NAND circuit, a NOR circuit, and a flip flop (FF). The cache controller 121 may include a computing apparatus whereby the units may be implemented by executing a program that implements functions and operations of the units. The units of the present embodiment will be described in detail.

The receiving unit 601 receives a reference request from the CPU 101 executing a program in which information indicative of the non-snoop reference request is distinguished from information indicative of the snoop reference request. The program is the execution code described above. For example, the receiving unit 601 receives the reference request when an enable signal is input by the CPU 101 to the “Load” signal line or the “Load_nc” signal line. Simultaneously with the output of the enable signal to the “Load” signal line or the “Load_nc” signal line, the CPU 101 outputs address information to the “Address” signal line.

If a non-snoop reference request is received by the receiving unit 601, the acquiring unit 602 acquires information stored in a specified area from the shared memory 103 without performing the snoop process. For example, if the “Load_nc” is received by the receiving unit 601, the acquiring unit 602 acquires, via the bus and the memory controller 104, data stored in an area in the shared memory 103 indicated by the address information input to the “Address” signal line.

The storing unit 603 then stores information acquired by the acquiring unit 602 into the cache memory 122 included in the CPU 101 executing the program. For example, the storing unit 603 outputs a signal indicative of “Write” to the “Read/Write” signal line and outputs “M” to the “State” signal line. At the same time, for example, the storing unit 603 outputs to the “Address” signal line first address information of an area in the shared memory 103 including the received address information and outputs data acquired by the acquiring unit 602 to the “Data” signal line. As a result, the cache memory 122 stores data acquired in one of the cache lines cl.

In the case of receiving a snoop reference request, if the cache memory 122 holds data stored in a specified area specified by the received reference request, the acquiring unit 602 does not acquire information stored in the specified area from the shared memory 103.

The receiving unit 601 receives an update request from the CPU 101 executing a program in which information indicative of the non-snoop update request is distinguished from information indicative of the snoop update request. For example, the receiving unit 601 receives the update request when an enable signal is input by the CPU 101 to the “Store” signal line or the “Store_nc” signal line. Simultaneously with the output of the enable signal to the “Store” signal line or the “Store_nc” signal line, the CPU 101 outputs address information to the “Address” signal line.

If a non-snoop update request is received by the receiving unit 601, the acquiring unit 602 acquires information stored in a specified area from the shared memory 103, without performing the snoop process. For example, if the “Store_nc” is received by the receiving unit 601, the acquiring unit 602 acquires, via the bus and the memory controller 104, data stored in an area in the shared memory 103 indicated by the address information input to the “Address” signal line.

The storing unit 603 then stores information obtained by the acquiring unit 602 into the cache memory 122 included in the CPU 101 executing the program. For example, the storing unit 603 outputs to the cache memory 122, a signal indicative of “Write” to the “Read/Write” signal line and “M” to the “State” signal line. At the same time, for example, the storing unit 603 outputs to the “Address” signal line, first address information of an area in the shared memory 103 including the received address information and outputs data acquired by the acquiring unit 602 to the “Data” signal line. As a result, the cache memory 122 stores data acquired in one of the cache lines cl.

In the case of receiving a snoop update request, if the cache memory 122 holds data stored in a specified area specified by the received update request, the acquiring unit 602 does not acquire information stored in the specified area from the shared memory 103.

Description will be given of the transition of state set in “State” in an ordinary reference request or update request and of the transition of state set in “State” in a reference request or update request according to the first embodiment.

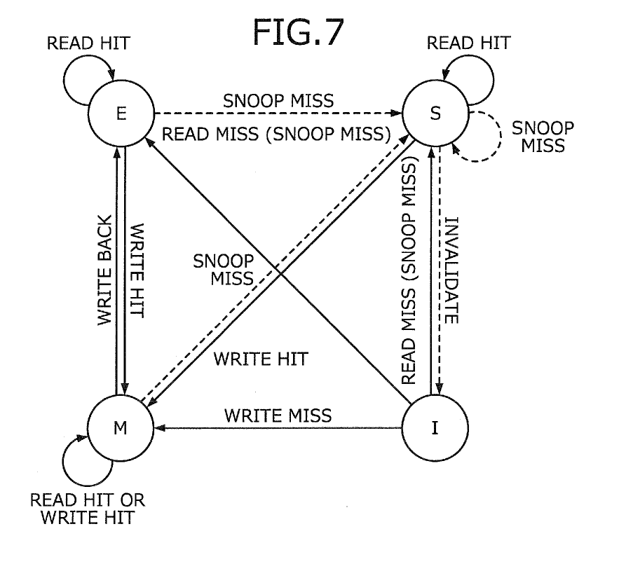

FIG. 7 is an explanatory view of an example of the state transition in the case of a snoop reference request or a snoop update request. FIG. 7 depicts a state transition diagram of “State” set in a cache line cl to be updated or referred to in response to a snoop update request or a snoop reference request received by the cache controller 121. In FIG. 7, the transition indicated by a solid line is a transition along a request received by the cache controller 121 controlling the cache memory 122 having the cache lines cl. The transition indicated by a broken line is a transition caused by the snoop process from the cache 102. Information added to the transition is a transition condition. If the transition condition is satisfied in each state, the state transitions. Each transition condition will be described.

“Read hit” indicates that the cache memory 122 controlled by the cache controller 121 receiving a snoop reference request holds data stored in an area in the shared memory 103 indicated by the snoop reference request.

“Read miss (Snoop hit)” indicates that the cache memory 122 controlled by the cache controller 121 receiving a snoop reference request does not hold data stored in an area in the shared memory 103 indicated by the snoop reference request and that the cache controller 121 succeeds in obtaining the data from another cache memory 122 through the snoop process.

“Read miss (Snoop miss)” indicates that the cache memory 122 controlled by the cache controller 121 receiving a snoop reference request does not hold data stored in an area in the shared memory 103 indicated by the snoop reference request and that the cache controller 121 cannot obtain the data from another cache memory through the snoop process and hence acquires the data from the shared memory 103.

“Write hit” indicates that the cache memory 122 controlled by the cache controller 121 receiving a snoop update request includes data stored in an area in the shared memory 103 indicated by the snoop update request and that the cache controller 121 overwrites data included in the snoop update request concerning the data.

“Write miss” indicates that the cache memory 122 controlled by the cache controller 121 receiving a snoop update request does not include data stored in an area in the shared memory 103 indicated by the snoop update request and therefore, further indicates that the cache controller 121 acquires data from another cache memory 122 through the snoop process and overwrites data included in the snoop update request concerning the data.

“Write back” indicates that a cache controller 121 receiving a snoop update request writes back data to an area in the shared memory 103 through the snoop process from another cache controller 121.

“Invalidate” indicates that when a cache controller 121 receives an invalidation process through the snoop process from another cache controller 121, the cache controller 121 invalidates a corresponding cache line cl.

“Snoop hit” indicates that another cache controller 121 receiving a snoop update request or a snoop reference request succeeds in obtaining desired data through the snoop process.

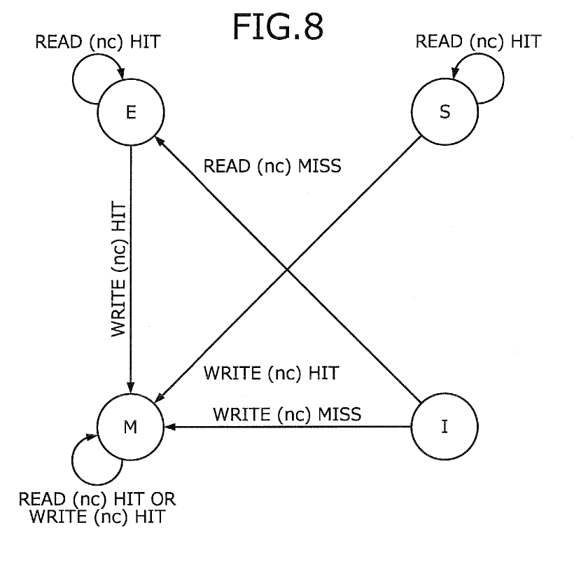

FIG. 8 is an explanatory view of an example of the state transition in the case of a non-snoop reference request or a non-snoop update request. FIG. 8 depicts a state transition diagram of “State” set in a cache line cl to be referred to or updated in response to an update request or a reference request of the first embodiment received by the cache controller 121.

In FIG. 8, the transition indicated by a solid line is a transition along a request received by the cache controller 121 controlling the cache memory 122 having the cache lines cl. Information added to the transition is a transition condition. If the transition condition is satisfied in each state, the state transitions.

If, for the update request and the reference request in the execution code, the snoop update request and the snoop reference request are exactly distinguished from the non-snoop update request and the non-snoop reference request, respectively, the transition to “S” state will not occur. Each transition condition will be described.

“Read(nc) hit” indicates that the cache memory 122 associated with the cache controller 121 receiving a non-snoop reference request holds data stored in an area in the shared memory 103 indicated by the non-snoop reference request.

“Read(nc) miss” indicates that the cache controller 121 receiving a non-snoop reference request acquires from the shared memory 103, data stored in an area in the shared memory 103 indicated by the non-snoop reference request and that the cache controller 121 stores the acquired data into the cache memory 122.

“Write(nc) hit” indicates that the cache memory 122 associated with cache controller 121 receiving a non-snoop update request holds data stored in an area in the shared memory 103 indicated by the non-snoop update request and that the cache controller 121 overwrites data included in the non-snoop update request concerning the data.

“Write(nc) miss” indicates that the cache memory 122 associated with the cache controller 121 receiving a non-snoop update request does not hold data stored in an area in the shared memory 103 indicated by the non-snoop update request and therefore, further indicates that the cache controller 121 acquires from the shared memory 103, data stored in an area in the shared memory 103 indicated by the non-snoop update request and overwrites data included in the non-snoop update request concerning the data.

As described in the first embodiment, in the case of a request for referring to a reference-only area in the shared memory, the area is not updated by another CPU and hence, the control apparatus acquires data stored in the area from the shared memory, without performing the snoop process. This achieves a reduction in the processing time and an improvement in the throughput.

As described in the first embodiment, in the case of a request for update of an update-only area in the shared memory, the area is not referred to by another CPU and hence, the control apparatus acquires data stored in the area from the shared memory without performing the snoop process. This achieves a reduction in the processing time and an improvement in the throughput. The control apparatus then stores the acquired data into the cache and thereafter overwrites data indicated by the update request concerning the stored data. This achieves a reduction in the processing time and an improvement in the throughput.

In the second embodiment, while executing a program by the simulator, the analysis apparatus analyzes whether a reference request and an update request are present for each area in the shared memory specified by the reference request or the update request. In the second embodiment, the analysis apparatus determines whether an area in the memory indicated by a reference request is updated with respect to information indicating the reference request in the program. Accordingly, the program designer refers to the result of the determination to discern whether information indicating a non-snoop reference request for a reference request included in the program is to be converted. Thus, the analysis apparatus can save time and effort of the program designer.

In the second embodiment, the analysis apparatus determines whether an area in the memory indicated by an update request is referred to for information indicating the update request in the program. Accordingly, the program designer refers to the result of the determination to discern information indicating a non-snoop update request for an update request included in the program is to be converted. Thus, the analysis apparatus can save time and effort of the program designer.

The hardware configuration of the analysis apparatus may be the same as that of the multi-core processor system of FIG. 5 or may be of a configuration that is not a multi-core processor.

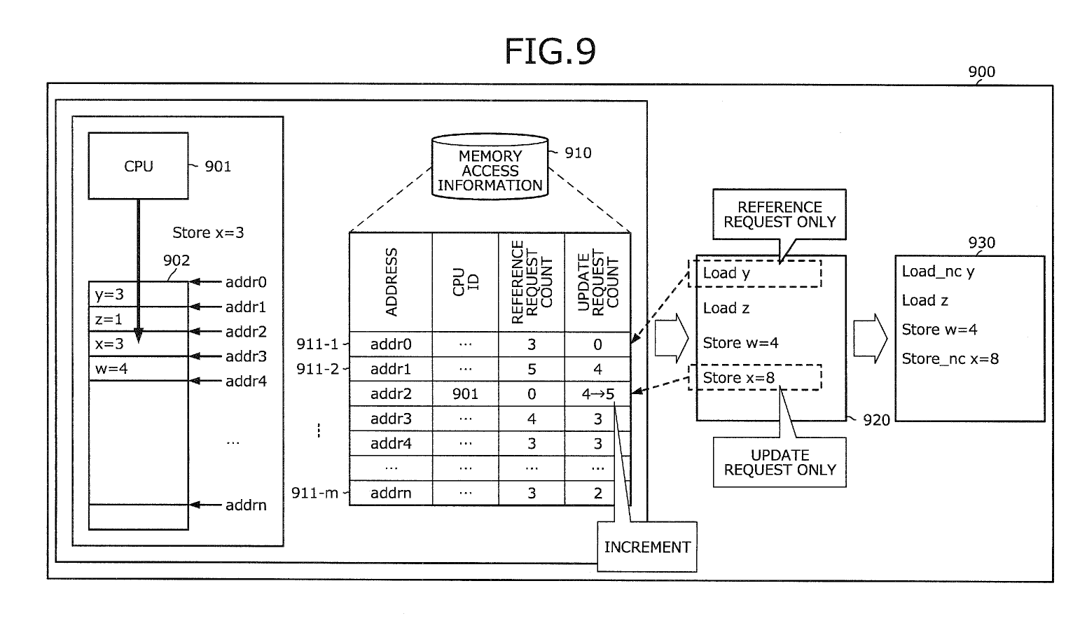

FIG. 9 is an explanatory view of an operation example of the analysis apparatus. Memory access information 910 depicted in FIG. 9 indicates for each area in a memory model, a count of specification by a reference request and a count of specification by an update request. The memory access information 910 includes fields for addresses, CPU IDs, reference request counts, and update request counts. Entered in the address field is a first address among plural areas of the memory model separated by the cache line size. In the address field, information is set in the order of address of the memory model and, for example, one area is indicated by an address addr0 to an address immediately before an address addr1. Entered in the CPU ID field is identification information of a CPU model that accesses the address entered in the address field. Entered in the reference request count field is the number of times that the reference request is issued for the address entered in the address field. Entered in the update request count field is the number of times that the update request is issued for the address entered in the address field. Information is set in the fields whereby, analysis information 911-1 to 911-m is stored as records.

First, during the execution of a program, an analysis apparatus 900 analyzes whether a reference request and an update request are present for each area in memory and specified by the reference request or the update request. As used herein, the program is an execution code 920. The analysis apparatus imparts a system model obtained by modeling the multi-core processor system, a verification pattern, and the execution code 920 to the simulator for simulation of the execution code 920.

The system model may be for example an electronic system level (ESL) model. The ESL model is described based on the behavior of a hardware device. When receiving the ESL model, the ESL simulator simulates the hardware environment described in the ESL model. The verification pattern is simulation conditions imparted to the execution code 920. For example, if the execution code 920 is a program relating to image processing, it may be image data for verification or conditions used when image data is processed through the image processing.

For example, while a CPU model 901 executes the execution code 920, the analysis apparatus 900 detects a reference request or an update request from the CPU model 901 to a memory model 902. For example, when detecting “Store x=3”, the analysis apparatus 900 identifies, from the memory access information 910, analysis information 911 having a first address of an area including an area indicated by an address indicative of the area where “x” is stored. For example, the analysis apparatus 900 enters identification information of the CPU model 901 into the CPU ID field of the identified analysis information 911. For example, the analysis apparatus 900 then increments the value set in the update request count field of the identified analysis information 911. In this manner, the memory access information 910 is updated by the analysis apparatus 900.

When the simulation by the simulator comes to an end, the analysis apparatus 900 determines based on the result of the analysis whether an area in the memory specified by the information indicating a reference request in the program is an area that is not specified by an update request. For example, the analysis apparatus 900 detects a description of “Load” in the execution code 920. For example, the analysis apparatus 900 identifies, from the memory access information 910, the analysis information 911 having a first address of an area including an area where the value of “y” of “Load y” is stored. For example, the analysis apparatus 900 then determines whether the value of the update request count included in the identified analysis information 911 is 0. For example, if the value of the update request count included in the identified analysis information 911 is 0, the analysis apparatus 900 determines that “Load y” is a reference request specifying an area that is not specified by an update request. The analysis apparatus 900 then outputs the result of the determination. For example, the analysis apparatus 900 may store the determination result into the storage 105 or may display the determination result on the display 107.

Accordingly, by referring to the determination result, the program designer can convert information indicating a reference request in the execution code 920 into information indicating a reference request specifying an area of the memory not having an update request. Thus, the analysis apparatus can save time and effort needed in the design of a program.

Furthermore, if determined to be an area that is not specified by an update request, the analysis apparatus 900 converts information indicative of a reference request into information indicative of a reference request specifying an area in the memory not having an update request. For example, the analysis apparatus 900 converts “Load y” into “Load_nc y”. The result of the conversion is stored to a storage device such as the storage. The execution code after conversion is an execution code 930.

Accordingly, upon receiving a reference request from the CPU executing a converted program, the cache controller can discern whether the reference request is a snoop reference request or a non-snoop reference request.

When the simulation by the simulator comes to an end, the analysis apparatus 900 determines based on the result of the analysis whether an area in the memory specified by the information indicative of an update request in the program is an area that is not specified by a reference request. For example, the analysis apparatus 900 detects description information “Store” in the execution code 920. For example, the analysis apparatus 900 specifies, from the memory access information 910, the analysis information 911 having a first address of an area including an area where the value of “x” of description information “Store x” is stored. For example, the analysis apparatus 900 then determines whether the value of the reference request count included in the specified analysis information 911 is 0. For example, if the value of the reference request count included in the specified analysis information 911 is 0, the analysis apparatus 900 determines that “Store x” is a non-snoop update request. The analysis apparatus 900 then outputs the result of the determination. For example, the analysis apparatus 900 may store the determination result into the storage 105 or may display the determination result on the display 107.

By referring to the determination result, the program designer can convert information indicative of an update request in the execution code 920 into information indicative of an update request specifying an area of the memory not having a reference request. Thus, the analysis apparatus can save time and effort needed for designing a program.

Furthermore, if determined to be an area that is not specified by a reference request, the analysis apparatus 900 converts information indicative of an update request into information indicative of an update request specifying an area in the memory not having a reference request. For example, the analysis apparatus 900 converts “Store x” into “Store_nc x”. The result of the conversion is stored to a storage device such as the storage. The execution code 930 is an execution code after conversion.

Accordingly, upon receiving an update request from the CPU executing a converted program, the cache controller can discriminate whether the update request is a snoop update request or a non-snoop update request. The analysis apparatus 900 can distinguish with a high accuracy, information indicative of a snoop update request from information indicative of a non-snoop update request in the program.

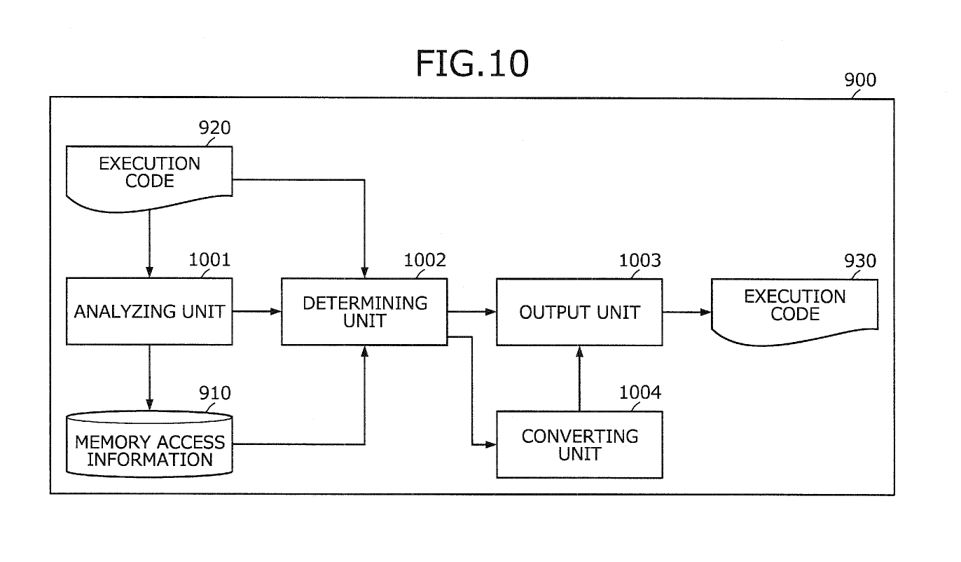

FIG. 10 is a block diagram of an example of functions of the analysis apparatus 900. The analysis apparatus 900 includes an analyzing unit 1001, a determining unit 1002, an output unit 1003, and a converting unit 1004. Processes of the analyzing unit 1001 to the converting unit 1004 are coded in an analysis program stored in a storage device such as the storage included in the analysis apparatus 900. One of the CPUs loads the analysis program from the storage device and executes processes coded in the analysis program and thereby, implements the functions from unit to unit.

Process results obtained by the function units are stored to a storage device such as the shared memory included in the analysis apparatus 900.

First, during the execution of a program, the analyzing unit 1001 analyzes for each area in the memory, whether specification is made by a reference request and whether specification is made by an update request. As described above, for example, the analyzing unit 1001, via the simulator, assigns the execution code 920 to a CPU model of the system model. For example, the analyzing unit 1001 analyzes a request from the CPU model to the memory model to create the memory access information 910.

The determining unit 1002 determines based on the analysis result whether an area in the memory specified by information indicative of a reference request in the program is an area that is not specified by an update request. The output unit 1003 outputs the result of the determination. For example, the output unit 1003 may cause the storage 105 to store the determination result or may display the determination result on the display 107.

If the area is an area that is not specified by the update request, the converting unit 1004 converts the information indicative of a reference request into information indicative of a reference request specifying a memory area not having an update request. For example, as depicted in FIG. 9, the converting unit 1004 converts “Load y” into “Load_nc y”. The output unit 1003 outputs the result of the conversion.

The determining unit 1002 determines based on the analysis result whether in the memory, an area specified by information indicative of an update request in the program is an area that is not specified by a reference request. The output unit 1003 outputs the result of the determination. For example, the output unit 1003 may cause the storage 105 to store the determination result or may display the determination result on the display 107.

If the area is an area that is not specified by the reference request, the converting unit 1004 converts the information indicative of an update request into information indicative of an update request specifying a memory area not having a reference request. For example, as depicted in FIG. 9, the converting unit 1004 converts “Store X” into “Store_nc x”.

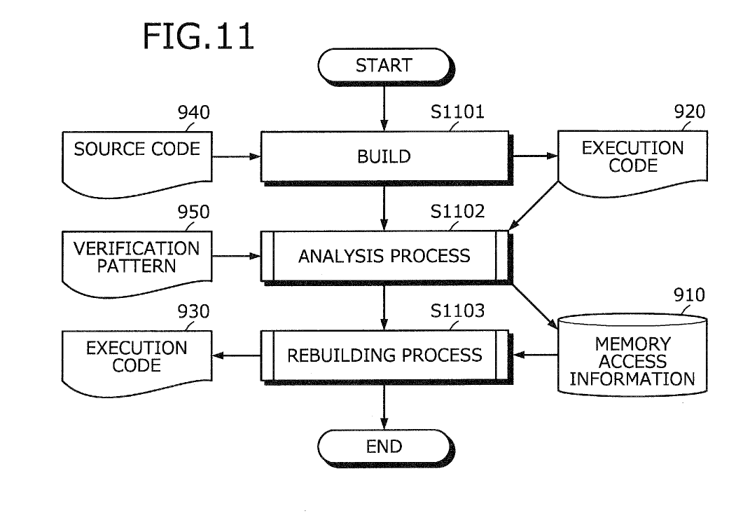

FIG. 11 is a flowchart of an example of an analysis procedure by the analysis apparatus 900. First, the analysis apparatus 900 builds source code 940 to generate execution code 920 (step S1101).

For example, if a variable a is only an update request variable, the designer of the source code 940 may describe an assignment expression “a=c+20;” as “a:=b+20;”. For example, at the time of building the source code 940, a compiler may output “a:=b+20;” as the execution code 920 and output “Load_nc” in place of “Load”.

The analysis apparatus 900 then imparts the execution code 920, a verification pattern 950, and a system model to the simulator to execute an analysis process (step S1102). The memory access information 910 is generated through the step S1102. The analysis apparatus 900 executes a rebuilding process to generate the execution code 930 (step S1103).

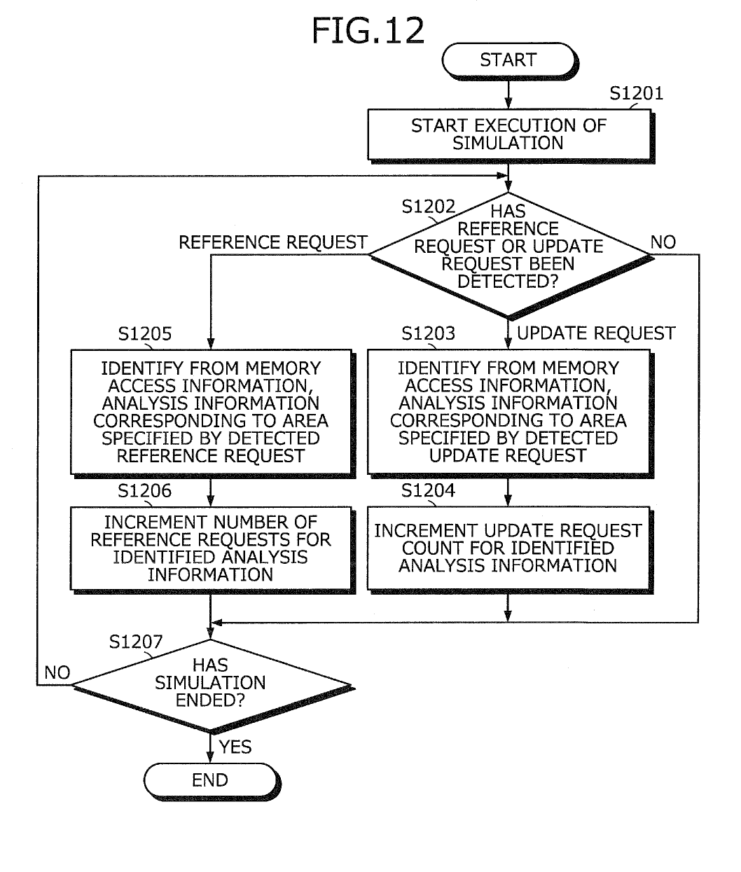

FIG. 12 is a flowchart of the analysis process example depicted in FIG. 11 (step S1102). The analysis apparatus 900 starts the execution of a simulation (step S1201) and determines whether a reference request or an update request has been detected (step S1202). If neither the reference request nor the update request has been detected (step S1202: NO), the procedure goes to step S1207. If an update request has been detected (step S1202: update request), the analysis apparatus 900 identifies from the memory access information 910, the analysis information 911 corresponding to an area that is specified by the detected update request (step S1203). The analysis apparatus 900 increments the number of update requests for the identified analysis information 911 (step S1204) and transitions to step S1207.

If a reference request has detected been (step S1202: reference request), the analysis apparatus 900 identifies from the memory access information 910, the analysis information 911 corresponding to an area that is specified by the detected reference request (step S1205). The analysis apparatus 900 increments the number of reference requests for the identified analysis information 911 (step S1206) and transitions to step S1207.

If “NO” at step S1202, the analysis apparatus 900 determines subsequent to step S1204 or step S1206 whether the simulation has ended (step S1207). If the simulation has not ended (step S1207: NO), the procedure returns to step S1202. If the simulation has ended (step S1207: YES), a series of operations come to an end.

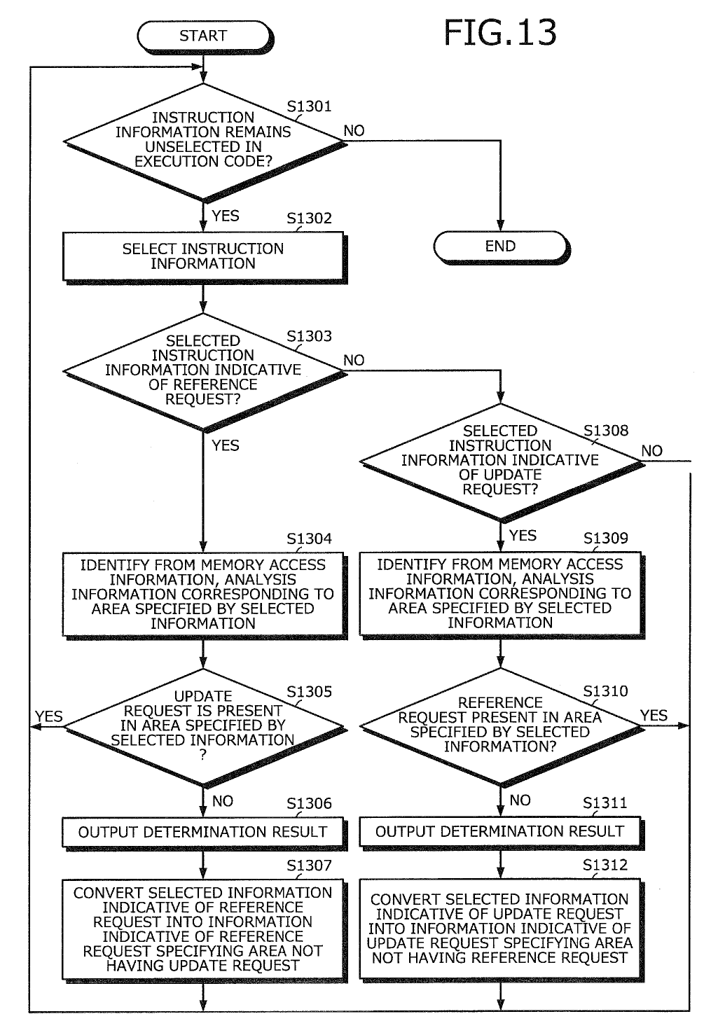

FIG. 13 is a flowchart of a first example of the rebuilding process (step S1103) depicted in FIG. 11. First, the analysis apparatus 900 determines whether instruction information remains unselected in the execution code 920 (step S1301). If unselected instruction information is present (step S1301: YES), the analysis apparatus 900 selects instruction information (step S1302).

The analysis apparatus 900 determines whether the selected instruction information is information indicative of a reference request (step S1303). If the selected instruction information is information indicative of a reference request (step S1303: YES), the analysis apparatus 900 identifies from the memory access information 910, analysis information 911 corresponding to an area specified by the selected information indicative of a reference request (step S1304).

The analysis apparatus 900 determines whether an update request is present in the area specified by the selected information indicative of a reference request (step S1305). If no update request is present in the area specified by the selected information indicative of a reference request (step S1305: NO), the analysis apparatus 900 outputs the result of the determination (step S1306).

The analysis apparatus 900 then converts the selected information indicative of a reference request into information indicative of a reference request specifying an area not having an update request (step S1307), and returns to step S1301. For example, in the example depicted FIG. 9, “Load y” is converted into “Load_nc y”. If the selected instruction information is not information indicative of a reference request (step S1303: NO), the analysis apparatus 900 determines whether the selected instruction information is information indicative of an update request (step S1308).

If the selected instruction information is information indicative of an update request (step S1308: YES), the analysis apparatus 900 identifies from the memory access information 910, analysis information 911 corresponding to an area specified by the selected information indicative of an update request (step S1309). The analysis apparatus 900 determines whether a reference request is present in the area specified by the selected information indicative of an update request (step S1310). If a reference request is present in the area specified by the selected information indicative of an update request (step S1310: YES), the procedure returns to step S1301.

If no reference request is present in the area specified by the selected information indicative of an update request (step S1310: NO), the analysis apparatus 900 outputs the result of the determination (step S1311). The analysis apparatus 900 then converts the selected information indicative of an update request into information indicative of an update request specifying an area not having a reference request (step S1312), and returns to step S1301. For example, in the example of FIG. 9, “Store x” is converted into “Store_nc x”.

At step S1305, if an update request is present in the area specified by the selected information indicative of a reference request (step S1305: YES), the procedure returns to step S1301.

At step S1308, if the selected instruction information is not information indicative of an update request (step S1308: NO), the procedure returns to step S1301.

At step S1301, if no instruction information remains unselected (step S1301: NO), a series of operations come to an end.

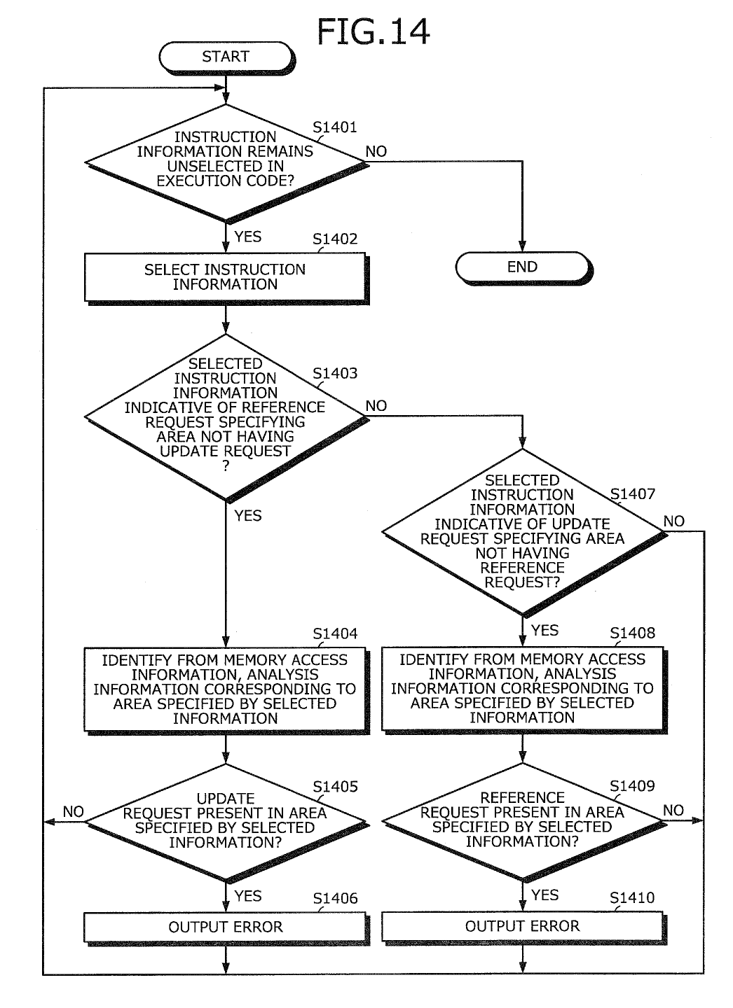

FIG. 14 is a flowchart of a second example of the rebuilding process (step S1103) depicted in FIG. 11. In FIG. 14, even though the program designer determines the reference request to be a non-snoop reference request and assigns “Load_nc” thereto, the analysis apparatus 900 outputs an error if the analysis apparatus 900 determines based on the analysis result that an update request is present in an area specified by the reference request. In FIG. 14, even though the program designer determines the update request to be a non-snoop update request and assigns “Store_nc” thereto, the analysis apparatus 900 outputs an error if the analysis apparatus 900 determines based on the analysis result that a reference request is present in an area specified by the update request.

For example, the analysis apparatus 900 first determines whether instruction information remains unselected in the execution code 920 (step S1401). If unselected instruction information is present (step S1401: YES), the analysis apparatus 900 selects instruction information (step S1402).

The analysis apparatus 900 determines whether the selected instruction information is information indicative of a reference request specifying an area not having an update request (step S1403). For example, the analysis apparatus 900 determines whether the selected instruction information is “Load_nc”. If the selected instruction information is information indicative of a reference request specifying an area not having an update request (step S1403: YES), the analysis apparatus 900 identifies from the memory access information 910, analysis information 911 corresponding to an area specified by the selected information indicative of a reference request (step S1404).

The analysis apparatus 900 determines whether an update request is present in the area specified by the selected information indicative of a reference request (step S1405). If an update request is present in the area specified by the selected information indicative of a reference request (step S1405: YES), the analysis apparatus 900 outputs an error (step S1406) to return to step S1401.

At step S1403, if the selected instruction information is not information indicative of a reference request specifying an area not having an update request (step S1403: NO), the analysis apparatus 900 determines whether the selected instruction information is information indicative of an update request specifying an area not having a reference request (step S1407). For example, the analysis apparatus 900 determines whether the selected instruction information is “Store_nc”.

If the selected instruction information is information indicative of an update request specifying an area not having a reference request (step S1407: YES), the analysis apparatus 900 identifies from the memory access information 910, the analysis information 911 corresponding to an area specified by the selected information indicative of an update request (step S1408).

The analysis apparatus 900 then determines whether a reference request is present in an area specified by the selected information indicative of an update request (step S1409). If no reference request is present in an area specified by the selected information indicative of an update request (step S1409: NO), the procedure returns to step S1401.

On the other hand, if a reference request is present in an area specified by the selected information indicative of an update request (step S1409: YES), the analysis apparatus 900 outputs an error (step S1410), and returns to step S1401.

At step S1407, if the selected instruction information is not information indicative of an update request (step S1407: NO), the procedure returns to step S1301.

At step S1401, if no instruction information remains unselected (step S1401: NO), a series of operations come to an end.

According to the first embodiment, in the case of a reference request for a reference only area in the shared memory, the area is not updated by the other CPUs and therefore, the control apparatus acquires data stored in the area from the shared memory without performing the snoop process. As a result, the control apparatus can reduce unnecessary snoop processes and improve the throughput.

In the case of a reference request to an area in the shared memory not having an update request, as long as the cache memory stores data to be referred to, the control apparatus can immediately respond to the CPU. Accordingly, as a result of not performing the snoop process, the control apparatus can reduce the processing time taken for the snoop process to improve the throughput.

According the first embodiment, in the case of an update request for an update only area in the shared memory, the area is not referred to by the other CPUs and therefore, the control apparatus acquires data stored in the area from the shared memory without performing the snoop process. After storing the acquired data into the cache, the control apparatus overwrites the stored data with update data included in the update request. As a result, the control apparatus can reduce unnecessary snoop processes and improve the throughput.

In the case of an update request to an area in the shared memory not having a reference request, as long as the cache memory stores data to be updated, the control apparatus can immediately respond to the CPU. Accordingly, as a result of not performing the snoop process, the control apparatus can reduce the processing time consumed for the snoop process and thereby, improve the throughput.

According to the second embodiment, during the execution of a program by the simulator, the analysis apparatus analyzes whether a reference request and an update request are present for each shared memory area specified by a reference request or an update request. The analysis apparatus then determines, for information indicative of a reference request in the program, whether an area in the memory indicated by the reference request is updated. Since the determination result is output, the analysis apparatus can save time and effort of the program designer in determining which reference request included in the program is to be converted into information indicative of a non-snoop reference request.

If it is determined based on the determination result that the area in the memory indicated by a reference request in the program is an area that is not specified by an update request, the analysis apparatus converts information indicative of the reference request into information indicative of a non-snoop reference request. The analysis apparatus can save time and effort of the program designer in determining whether each reference request is a non-snoop reference request. Furthermore, when the cache controller receives a reference request from a CPU executing the converted program, the cache controller can discriminate whether the reference request is a snoop reference request or a non-snoop reference request.

According to the second embodiment, during the execution of a program by the simulator, the analysis apparatus analyzes whether a reference request and an update request are present for each area in the shared memory specified by a reference request or an update request. The analysis apparatus then determines, for information indicative of an update request in the program, whether an area in the memory indicated by the update request is referred to. Since the determination result is output, the analysis apparatus can save time and effort of the program designer in determining which update request included in the program is to be converted into information indicative of a non-snoop update request.

If it is determined based on the determination result that the area in the memory indicated by an update request in the program is an area that is not specified by a reference request, the analysis apparatus converts information indicative of the update request into information indicative of a non-snoop update request. Furthermore, when the cache controller receives an update request from a CPU executing the converted program, the cache controller can discriminate whether the update request is a snoop update request or a non-snoop update request.

The analysis method described in the second embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiments, an increase in the throughput can be achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control apparatus that, for each memory configured to temporarily store first information that is stored in a shared memory shared by a plurality of CPUs respectively having the memories or second information that is to be stored in the shared memory, controls access from each of the CPUs to the memories, the control apparatus comprising:
a receiving unit configured to receive any one among a first and a second reference request from a CPU executing a program in which information indicative of the first reference request specifying in the shared memory, an area not having an update request is distinguished from information indicative of the second reference request specifying in the shared memory, an area having an update request;
an acquiring unit configured to acquire from the shared memory and when the receiving unit receives the first reference request, the first information stored in the specified area, the acquiring unit acquiring the first information without performing for the first information stored in the specified area or the second information, a snoop process that is based on a storage state of the memory of the CPU executing the program; and
a storing unit that stores into the memory of the CPU executing the program, the information acquired by the acquiring unit.

2. The control apparatus according to claim 1, wherein
the acquiring unit, when the receiving unit receives the second reference request, refrains from acquiring the first information stored in the specified area, when data stored in the specified area is stored in the memory of the CPU executing the program.

3. A control apparatus that, for each memory configured to temporarily store first information that is stored in a shared memory shared by a plurality of CPUs respectively having the memories or second information that is to be stored in the shared memory, controls access from each of the CPUs to the memories, the control apparatus comprising:
a receiving unit configured to receive any one among a first and a second update request from a CPU executing a program in which information indicative of the first update request specifying in the shared memory, an area not having a reference request is distinguished from information indicative of the second update request specifying in the shared memory, an area having a reference request;
an acquiring unit configured to acquire from the shared memory and when the receiving unit receives the first update request, the first information stored in the specified area, the acquiring unit acquiring the first information without performing for the first information stored in the specified area or the second information, a snoop process that is based on a storage state of the memory of the CPU executing the program; and
a storing unit that stores into the memory of the CPU executing the program, the information acquired by the acquiring unit.

4. The control apparatus according to claim 3, wherein
the acquiring unit, when the receiving unit receives the second update request, refrains from acquiring the first information stored in the specified area, when data stored in the specified area is stored in the memory of the CPU executing the program.

5. An analysis apparatus comprising
a processor configured to:
analyze during execution of a program and for each area in a memory, whether the area is specified by a reference request and whether the area is specified by an update request;
determine based on an analysis result, whether in the memory, the area specified by information indicative of the reference request in the program is an area that is not specified by the update request; and
output a determination result.

6. An analysis apparatus comprising
a processor configured to:
analyze during execution of a program and for each area in a memory, whether the area is specified by a reference request and whether the area is specified by an update request;
determine based on an analysis result, whether in the memory, the area specified by information indicative of the update request in the program is an area that is not specified by the reference request; and
output a determination result.

7. An analysis method comprising:
analyzing during execution of a program and for each area in a memory, whether the area is specified by a reference request and whether the area is specified by an update request;
determining based on an analysis result, whether in the memory, the area specified by information indicative of the reference request in the program is an area that is not specified by the update request; and
outputting a determination result, wherein the analysis method is executed by a computer.

8. The analysis method according to claim 7, further comprising
converting, when the area is determined to be an area that is not specified by the update request, the information indicative of the reference request into information indicative of a reference request specifying in the memory, an area not having the update request.

9. An analysis method comprising:
analyzing during execution of a program and for each area in a memory, whether the area is specified by a reference request and whether the area is specified by an update request;
determining based on an analysis result, whether in the memory, the area specified by information indicative of the update request in the program is an area that is not specified by the reference request; and
outputting a determination result, wherein
the analysis method is executed by a computer.

10. The analysis method according to claim 9, further comprising
converting, when the area is determined to be an area that is not specified by the reference request, the information indicative of the update request in the program into information indicative of an update request specifying in the memory, an area not having the reference request.

11. A non-transitory, computer-readable recording medium storing an analysis program that causes a computer to execute a process comprising:
analyzing during execution of a program and for each area in a memory, whether the area is specified by a reference request and whether the area is specified by an update request;
determining based on an analysis result, whether in the memory, the area specified by information indicative of the reference request in the program is an area that is not specified by the update request; and
outputting a determination result, wherein
the analysis method is executed by a computer.

12. A non-transitory, computer-readable recording medium storing an analysis program that causes comprising:
analyzing during execution of a program and for each area in a memory, whether the area is specified by a reference request and whether the area is specified by an update request;
determining based on an analysis result, whether in the memory, the area specified by information indicative of the update request in the program is an area that is not specified by the reference request; and
outputting a determination result, wherein
the analysis method is executed by a computer.
